(19) United States
(12) Patent Application Publication
(10) Pub. No.: US 2006/0149820 A1
(43) Pub. Date: Jul. 6, 2006

(54) Detecting spam e-mail using similarity calculations

(75) Inventors: Vadakkedathu T. Rajan, Briarcliff Manor, NY (US); Mark N. Wegman, Ossining, NY (US); Richard B. Segal, Chappaqua, NY (US); Jason L. Crawford, Ossining, NY (US); Joel Ossher, South Salem, NY (US); Jeffrey O. Kephart, Cortlandt Manor, NY (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 11/028,969

(22) Filed: Jan. 4, 2005

(51) Int. Cl. G06F 15/16

(52) U.S. Cl. 709/206

(57) ABSTRACT

A method for detecting undesirable e-mails is disclosed. The method includes collecting a plurality of undesirable e-mails, arranging the plurality of undesirable e-mails into a plurality of groups and generating, for each group, at least one token, thereby producing a plurality of tokens for the plurality of undesirable e-mails. The method further includes receiving a first e-mail and generating at least one token for the first e-mail. The method further includes causing a comparison of the at least one token for the first e-mail with at least one of the plurality of tokens for the plurality of undesirable e-mails and identifying the first e-mail as an undesirable e-mail if the at least one token for the first e-mail matches any of the plurality of tokens for the plurality of undesirable e-mails.

### CROSS-REFERENCE TO RELATED APPLICATIONS

Not Applicable.

### COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of electronic mail or e-mail and more particularly relates to the field of detecting and eliminating unsolicited e-mail or spam.

### BACKGROUND OF THE INVENTION

The emergence of electronic mail or e-mail has changed the face of modern communication. Today, millions of people every day use e-mail to communicate instantaneously across the world and over international and cultural boundaries. The Nielsen polling group estimates that the United States alone boasts 183 million e-mail users out of a total population of 280 million. The use of e-mail, however, has not come without its drawbacks.

Almost as soon as e-mail technology emerged, so did unsolicited e-mail, also known as spam. Unsolicited e-mail typically comprises an e-mail message that advertises or attempts to sell items to recipients who have not asked to receive the e-mail. Most spam is commercial advertising for products, pornographic web sites, get-rich-quick schemes, or quasi-legal services. Spam costs the sender very little to send - most of the costs are paid for by the recipient or the carriers rather than by the sender. Reminiscent of excessive mass solicitations via postal services, facsimile transmissions, and telephone calls, an e-mail recipient may receive hundreds of unsolicited e-mails over a short period of time. On average, Americans receive 155 unsolicited messages in their personal or work e-mail accounts each week with 20 percent of e-mail users receiving 200 or more. This results in a net loss of time, as workers must open and delete spam e-mails. Similar to the task of handling “junk” postal mail and faxes, an e-mail recipient must laboriously sift through his or her incoming mail simply to sort out the unsolicited spam e-mail from legitimate e-mails. As such, unsolicited e-mail is no longer a mere annoyance—its elimination is one of the biggest challenges facing businesses and their information technology infrastructure. Technology, education and legislation have all taken roles in the fight against spam.

Presently, a variety of methods exist for detecting, labeling and removing spam. Vendors of electronic mail servers, as well as many third-party vendors, offer spam-blocking software to detect, label and sometimes automatically remove spam. The following U.S. Patents, which disclose methods for detecting and eliminating spam, are hereby incorporated by reference in their entirety: U.S. Pat. No. 5,999,932 entitled “System and Method for Filtering Unsolicited Electronic Mail Messages Using Data Matching and Heuristic Processing,” U.S. Pat. No. 6,023,723 entitled “Method and System for Filtering Unwanted Junk E-Mail Utilizing a Plurality of Filtering Mechanisms,” U.S. Pat. No. 6,029,164 entitled “Method and Apparatus for Organizing and Accessing Electronic Mail Messages Using Labels and Full Text and Label Indexing,” U.S. Pat. No. 6,092,101 entitled “Method for Filtering Mail Messages for a Plurality of Client Computers Connected to a Mail Service System,” U.S. Pat. No. 6,161,130 entitled “Technique Which Utilizes a Probabilistic Classifier to Detect Junk E-Mail by Automatically Updating A Training and Re-Training the Classifier Based on the Updated Training List,” U.S. Pat. No. 6,167,434 entitled “Computer Code for Removing Junk E-Mail Messages,” U.S. Pat. No. 6,199,102 entitled “Method and System for Filtering Electronic Messages,” U.S. Pat. No. 6,249,805 entitled “Method and System for Filtering Unauthorized Electronic Mail Messages,” U.S. Pat. No. 6,266,692 entitled “Method for Blocking All Unwanted E-Mail (Spam) Using a Header-Based Password,” U.S. Pat. No. 6,324,569 entitled “Self-Removing E-mail Verified or Designated as Such by a Message Distributor for the Convenience of a Recipient,” U.S. Pat. No. 6,330,590 entitled “Preventing Delivery of Unwanted Bulk E-Mail,” U.S. Pat. No. 6,421,709 entitled “E-Mail Filter and Method Thereof,” U.S. Pat. No. 6,484,197 entitled “Filtering Incoming E-Mail,” U.S. Pat. No. 6,487,586 entitled “Self-Removing E-mail Verified or Designated as Such by a Message Distributor for the Convenience of a Recipient,” U.S. Pat. No. 6,493,007 entitled “Method and Device for Removing Junk E-Mail Messages,” and U.S. Pat. No. 6,654,787 entitled “Method and Apparatus for Filtering E-Mail.”

One known method for eliminating spam is to compare incoming messages to a corpus of known spam. E-mail that is deemed sufficiently similar to known spam is identified as spam and filtered out of the user's inbox. To employ this technique, a corpus of known spam must be collected. One known method to collect known spam employs the use of a “decoy” or “honey pot” e-mail accounts, each having an address that has never been used to solicit e-mails from third parties. The addresses of the honey pot e-mail accounts are publicized so as to attract spammers. Any e-mails that are received by honey pot e-mail accounts are deemed automatically to be, by definition, unsolicited e-mails, or spam. A second existing method for collecting known spam is to collect e-mails for which the recipient has indicated that the message is spam. The indication of spam is typically achieved by asking the user to press a button to mark an incoming message as spam, but can be accomplished using a variety of techniques.

To filter spam using a corpus of known spam, all incoming mail is first compared with the spam in the corpus. If the incoming e-mail matches any of the spam in the spam corpus, the incoming mail is deemed to be spam and treated accordingly. If the incoming e-mail does not match any of the spam in the spam corpus, the incoming e-mail is not deemed to be spam and is delivered to the addressed recipient's mailbox. Unfortunately, spammers regularly circumvent spam filters by introducing superficial variations into spam messages, typically by adding, deleting and/or modifying textual content. Spam filters may then fail to recognize the underlying similarity of spam messages with a common origin, allowing spam to slip past the filters into the user's inbox.

Therefore, a need exists to overcome the problems with the prior art as discussed above, and particularly for a way to simplify the task of detecting and eliminating spam e-mail.

### SUMMARY OF THE INVENTION

Briefly, according to an embodiment of the present invention, a method for detecting undesirable e-mails is disclosed. The method includes collecting a plurality of undesirable e-mails, arranging the plurality of undesirable e-mails into a plurality of groups and generating, for each group, at least one token, thereby producing a plurality of tokens for the plurality of undesirable e-mails. The method further includes receiving a first e-mail and generating at least one token for the first e-mail. The method further includes causing a comparison of the at least one token for the first e-mail with at least one of the plurality of tokens for the plurality of undesirable e-mails and identifying the first e-mail as an undesirable e-mail if the at least one token for the first e-mail matches any of the plurality of tokens for the plurality of undesirable e-mails.

In another embodiment of the present invention, an information processing system for detecting undesirable e-mail is disclosed. The information processing system includes a memory for collecting a plurality of undesirable e-mails and a receiver for receiving a first e-mail. The information processing system further includes a processor configured for arranging the plurality of undesirable e-mails into a plurality of groups, generating, for each group, at least one token, thereby producing a plurality of tokens for the plurality of undesirable e-mails, generating at least one token for the first e-mail, causing a comparison of the at least one token for the first e-mail with at least one of the plurality of tokens for the plurality of undesirable e-mails and identifying the first e-mail as an undesirable e-mail if the at least one token for the first e-mail matches any of the plurality of tokens for the plurality of undesirable e-mails.

In another embodiment of the present invention, a computer readable medium including computer instructions for detecting undesirable e-mail is disclosed. The computer instructions include instructions for collecting a plurality of undesirable e-mails and arranging the plurality of undesirable e-mails into a plurality of groups. The computer instructions further include instructions for generating, for each group, at least one token, thereby producing a plurality of tokens for the plurality of undesirable e-mails, receiving a first e-mail and generating at least one token for the first e-mail. The computer instructions further include instructions for causing a comparison of the at least one token for the first e-mail with at least one of the plurality of tokens for the plurality of undesirable e-mails and identifying the first e-mail as an undesirable e-mail if the at least one token for the first e-mail matches any of the plurality of tokens for the plurality of undesirable e-mails.

In another embodiment of the present invention, a method for detecting undesirable e-mails is disclosed. The method includes collecting a plurality of desirable and undesirable e-mails and generating at least one token for the plurality of desirable and undesirable e-mails. The method further includes receiving a first e-mail and generating at least one token for the first e-mail. The method further includes causing a comparison of the at least one token for the first e-mail with at least one of the plurality of tokens for the plurality of desirable and undesirable e-mails and identifying the first e-mail as desirable or undesirable e-mail based on the result of the comparison between at least one token for the first e-mail with at least one of the plurality of tokens for the plurality of desirable or undesirable e-mails.

In another embodiment of the present invention, a method for detecting undesirable e-mails is disclosed. The method includes collecting a plurality of undesirable e-mails, generating at least one token for the plurality of undesirable e-mails, thereby producing a plurality of tokens for the plurality of undesirable e-mails and generating a weight associated with each of the plurality of tokens, wherein a weight is based on token length. The method further includes receiving a first e-mail and generating at least one token for the first e-mail. The method further includes causing a comparison of the at least one token for the first e-mail with at least one of the plurality of tokens for the plurality of undesirable e-mails and identifying the first e-mail as an undesirable e-mail if the at least one token for the first e-mail matches any of the plurality of tokens for the plurality of undesirable e-mails.

### BRIEF DESCRIPTION OF THE DRAWINGS

FIG. 1 is block diagram showing the network architecture of one embodiment of the present invention.

FIG. 2 is an illustration of an e-mail viewed in a graphical user interface, showing the generation of tokens for an e-mail, according to one embodiment of the present invention.

FIG. 3 is block diagram showing the generation of tokens from desirable and undesirable e-mail corpora, according to one embodiment of the present invention.

FIG. 4 is block diagram showing the process of detecting undesirable e-mails using similarity calculations, according to one embodiment of the present invention.

FIG. 5 is a flowchart showing the control flow of the process of detecting undesirable e-mails using similarity calculations, according to one embodiment of the present invention.

FIG. 6 is a high level block diagram showing an information processing system useful for implementing one embodiment of the present invention.

### DETAILED DESCRIPTION

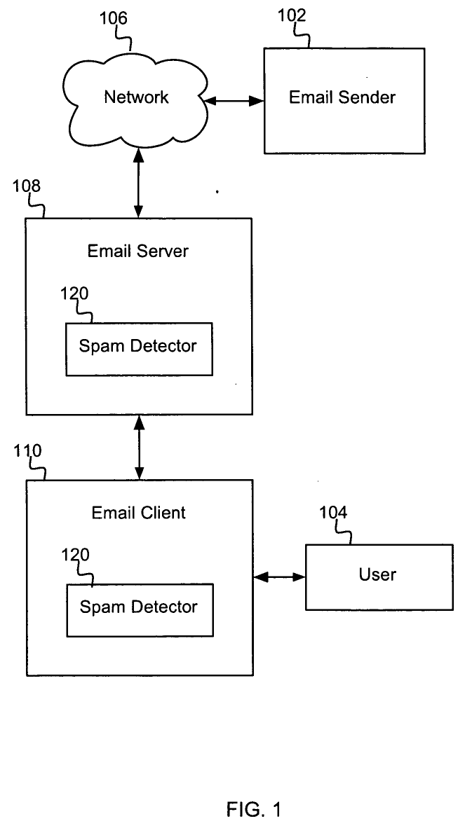

FIG. 1 is block diagram showing a high-level network architecture according to an embodiment of the present invention. FIG. 1 shows an e-mail server 108 connected to a network 106. The e-mail server 108 provides e-mail services to a local area network (LAN) and is described in greater detail below. The e-mail server 108 comprises any commercially available e-mail server system that can be programmed to offer the functions of the present invention. FIG. 1 further shows an e-mail client 110, comprising a client application running on a client computer, operated by a user 104. The e-mail client 110 offers an e-mail application to the user 104 for handling and processing e-mail. The user 104 interacts with the e-mail client 110 to read and otherwise manage e-mail functions.

FIG. 1 further includes a spam detector 120 for processing e-mail messages and detecting undesirable, or spam, e-mail, in accordance with one embodiment of the present invention. The spam detector 120 can be implemented as hardware, software or any combination of the two. Note that the spam detector 120 can be located in either the e-mail server 108 6r the e-mail client 110 or there between. Alternatively, the spam detector 120 can be located in a distributed fashion in both the e-mail server 108 and the e-mail client 110. In this embodiment, the spam detector 120 operates in a distributed computing paradigm.

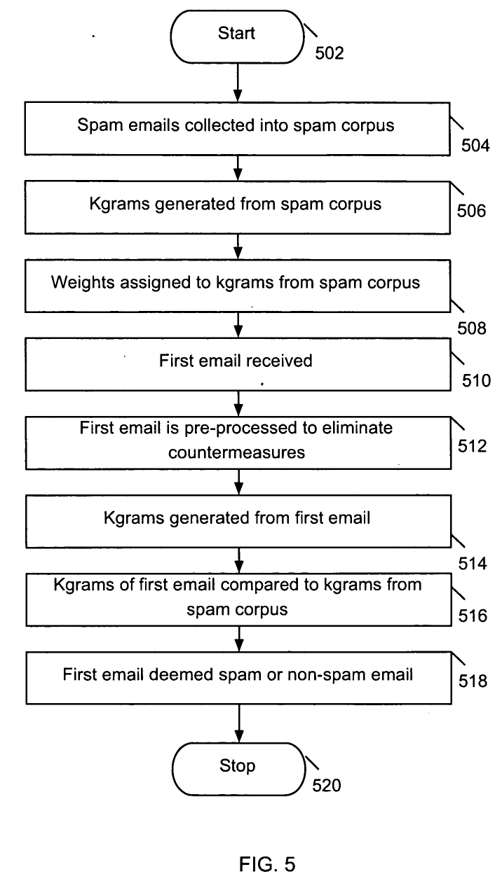

FIG. 1 further shows an e-mail sender 102 connected to the network 106. The e-mail sender 102 can be an individual, a corporation, or any other entity that has the capability to send an e-mail message over a network such as network 106. The path of an e-mail in FIG. 1 begins, for example, at e-mail sender 102. The e-mail then travels through the network 106 and is received by an e-mail server 108, where it is optionally processed according to the present invention by the spam detector 120. Next, the processed e-mail is sent to the recipient, e-mail client 110, where it is optionally processed by the spam detector 120 and eventually viewed by the user 104. This process is described in greater detail with reference to FIG. 5 below.

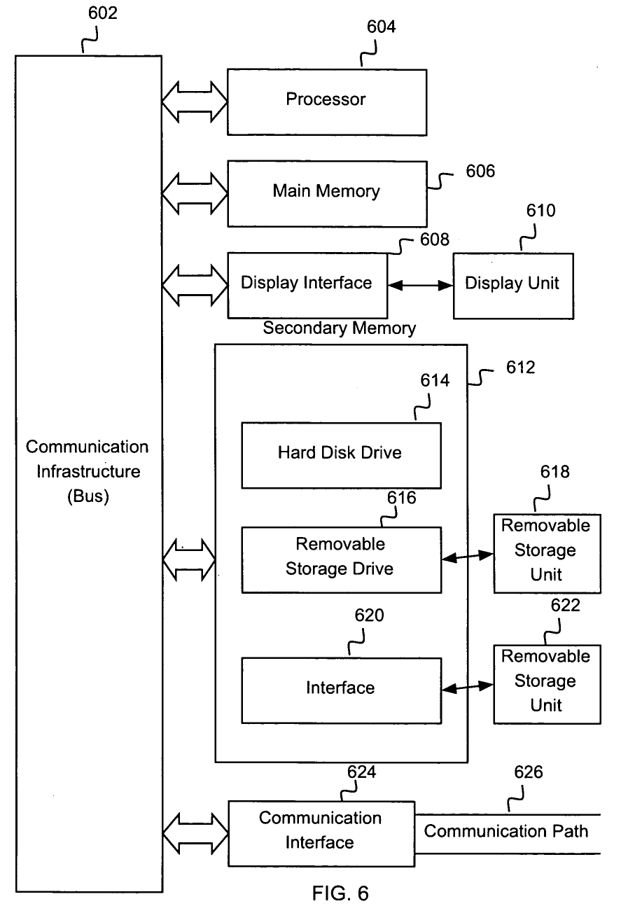

In an embodiment of the present invention, the computer systems of the e-mail client 110 and the e-mail server 108 are one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer systems of the e-mail client 110 and the e-mail server 108 are a server system (e.g., SUN Ultra workstations running the SunOS operating system or IBM RS/6000 workstations and servers running the AIX operating system). The computer systems of the e-mail client 110 and the e-mail server 108 are described in greater detail below with reference to FIG. 6.

In another embodiment of the present invention, the network 106 is a circuit switched network, such as the Public Service Telephone Network (PSTN). In yet another embodiment, the network 106 is a packet switched network. The packet switched network is a wide area network (WAN), such as the global Internet, a private WAN, a telecommunications network or any combination of the above-mentioned networks. In yet another embodiment, the network 106 is a wired network, a wireless network, a broadcast network or a point-to-point network.

It should be noted that although e-mail server 108 and e-mail client 110 are shown as separate entities in FIG. 1, the functions of both entities may be integrated into a single entity. It should also be noted that although FIG. 1 shows one e-mail client 110 and one e-mail sender 102, the present invention can be implemented with any number of e-mail clients and any number of e-mail senders.

A token is a unit representing data or metadata of an e-mail or group of e-mails. A token can be a string of contiguous characters (of fixed or non-fixed length) from an e-mail. A token may also comprise a string of characters from an e-mail, wherein a hash of the string of characters meets a specified criterion, such as the hash ending in “00.” A k-gram is a form of token that consists of a string of “k” consecutive data components. The use of k-grams for document matching is well known. See Aiken, Alex (2003), Winnowing: Local Algorithms for Document Fingerprinting, In Proceedings of the ACM SIGMOD International Conference on Management of Data.

K-grams have been employed in text similarity matching, as well as in computer virus detection. U.S. Pat. No. 5,440,723 entitled “Automatic Immune System for Computers and Computer Networks” and U.S. Pat. No. 5,452,442 entitled “Methods and Apparatus for Evaluating and Extracting Signatures of Computer Viruses and Other Undesirable Software Entities,” the disclosures of which are hereby incorporated by reference in their entirety, teach several methods for developing k-grams employed as signatures of known computer viruses. These patents likewise teach the development of “fuzzy” k-grams that provide further immunization from obfuscation sometimes employed by computer viruses upon their replication.

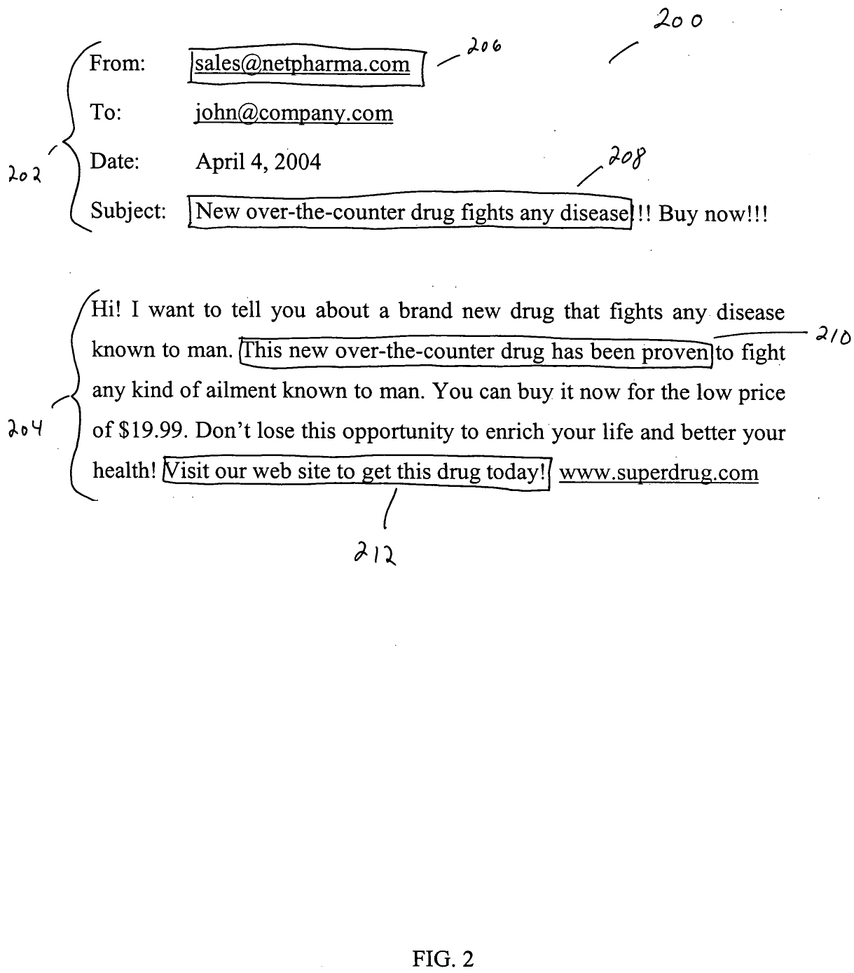

A k-gram can be considered a signature, or identifying feature, of an e-mail. FIG. 2 is an illustration of an e-mail 200 viewed in a graphical user interface, showing the generation of k-grams for the e-mail 200, according to one embodiment of the present invention. FIG. 2 shows a typical undesirable e-mail 200 advertising a product. The e-mail 200 includes a header 202, which includes standard fields such as from, to, date and subject and a message body 204 that includes that the major advertising portion of the e-mail message.

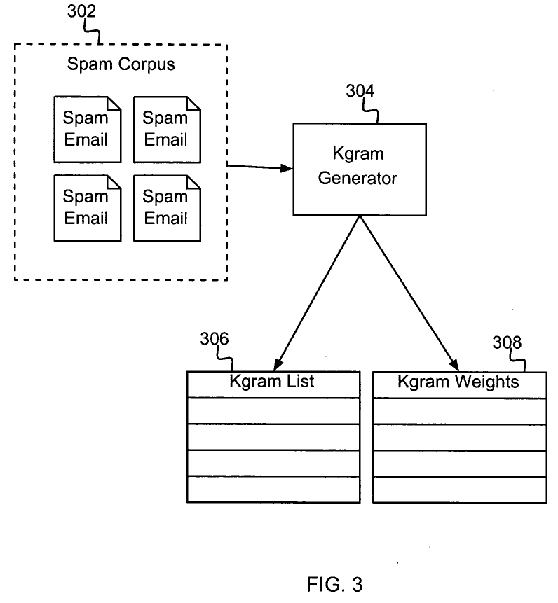

FIG. 2 shows an example of several k-grams taken from the e-mail 200. K-gram 206 comprises nineteen consecutive characters that encompass the entire e-mail address of the sender. K-gram 208 comprises 44 consecutive characters that include data from the subject line of the e-mail 200. K-gram 210 comprises 46 consecutive characters from the body of the e-mail 200. K-gram 212 comprises 42 consecutive characters from the body of the e-mail 200. In an embodiment of the present invention, a k-gram consists of 20 to 30 consecutive characters from the e-mail 200, and one k-gram is generated for every 100 characters in an e-mail. In another embodiment of the present invention, a k-gram does not include white space. In another embodiment of the present invention, a k-gram does not include white space or punctuation. The generation of k-grams from an e-mail by spam detector 120 is described in greater detail below with reference to FIGS. 3-5.

It should be noted that the number of k-grams generated for an e-mail, as well as the size of each k-gram, is variable. That is, the number of k-grams generated for an e-mail and the size of each k-gram may vary or be dependent on other variables, such as: the number of spam e-mails in a spam corpus that must be processed for k-grams, the type of spam e-mails that must be processed, the number of incoming e-mails that must be processed for k-grams in order to determine whether they are spam, the amount and type of processing resources available, the amount and type of memory available, the presence of other, higher-priority processing jobs, and the like.

In addition to the generation of k-grams from e-mail 200, k-gram weight values can also be generated. That is, weight values are assigned to each k-gram depending on the relevance of each k-gram to the detection of a spam e-mail. For example, “from” e-mail addresses in unsolicited e-mail, such as reflected in k-gram 206, are often forged, or spoofed. Thus, the “from” e-mail address of e-mail 200 is probably not genuine. For this reason, k-gram 206 probably does not hold much relevance to the detection of spam. Therefore, a low k-gram weight value would be attributed to k-gram 206. On the other hand, information in the message body, such as reflected in k-gram 210, is often indicative of undesirable e-mail. For this reason, k-gram 201 probably holds much relevance to the detection of spam. Therefore, a high k-gram weight value would be attributed to k-gram 210. Some tokens are not useful for comparing e-mail messages because they are common to a wide variety of messages. For instance, k-gram XXX is an HTML expression that appears in most HTML e-mails. Therefore, the fact that two messages contain this k-gram is not necessarily indicative of the two messages being similar. K-grams common to many e-mails should be given lower weight.

In one embodiment of the present invention, k-gram weight values range from 0 to 1, with 0 being a low k-gram weight value and 1 being the highest k-gram weight value. In another embodiment of the present invention, the k-grams generated for an e-mail are fuzzy k-grams, which are better suited for detecting spam e-mail that has been disguised. In another embodiment of the present invention, k-gram weight values are associated with the length of the token, or k-gram. Since a token is a representation of data or metadata of en e-mail, the length of a token or k-gram represents an amount of data or metadata. For this reason, tokens or k-grams of greater length can be given greater weights.

In yet another embodiment of the present invention, k-gram weight values are computed based on their intra-group and inter-group frequency. A k-gram that appears only within a single group of similar messages is likely to be representative of the group and indicative of group membership; while a k-gram that appears in many groups is likely to be a common term that is not indicative of e-mail similarity. In this embodiment, e-mails that are very similar, that is their similarity is above a specified threshold, are placed into a group. Tokens which are common to the e-mails within a group are given higher weights, and correspondingly, tokens that appear in many different groups are assigned lower weights.

In yet another embodiment of the present invention, k-gram weight values are computed based on the relative frequency of a k-grams occurrence in desirable and undesirable e-mail. For instance, k-grams that occur in greater than a specified number of times in desirable e-mail can be given zero weight or eliminated. Alternatively, k-grams can be assigned weights equal to the fraction of e-mails that include the k-gram that are undesirable.

In yet another embodiment of the present invention, k-gram weight values are computed from the estimated probability of occurrence of the k-gram in non-spam e-mail. Specifically, a large corpus of non-spam e-mail is analyzed to determine the frequency of all character sequences of length n or less. A method of estimating k-gram or fuzzy k-gram probabilities from frequencies of shorter-length character sequences is given in [U.S. Pat. No. 5,452,442, “Method and apparatus for evaluating and extracting signatures of computer viruses and other undesirable software entities”, Kephart]. In practice, this method can underestimate probabilities by an amount that grows in the length of the k-gram, so the estimated probability may be multiplied by an empirical length correction factor that is greater than one, and which grows with length. The k-gram weight can be taken as a function of the (possibly corrected) k-gram probability. In a preferred embodiment, the k-gram weight is taken to be −1 times the logarithm of the computed k-gram probability. In another preferred embodiment, this is scaled to yield k-gram weights that are between 0 and 1.

FIG. 3 is block diagram showing the generation of k-grams from an undesirable e-mail corpus 302, according to one embodiment of the present invention. FIG. 3 shows a spam corpus 302 comprising a plurality of spam e-mails organized into groups. The spam corpus 302 is used to learn how to identify spam e-mail and distinguish it from non-spam e-mail. In one embodiment of the present invention, a spam corpus is generated by creating a bogus e-mail account, perhaps belonging to a fictitious person, where no e-mails are expected or solicited. Thus, any e-mails that are received by this e-mail account are deemed automatically to be, by definition, unsolicited e-mails, or spam. This type of e-mail account is often referred to as a honey pot e-mail account or simply a honey pot. In another embodiment of the present invention, the spam corpus is generated or supplemented by reading a known set of undesirable e-mails provided by a peer or other entity that has confirmed the identity of the e-mails as spam.

FIG. 3 also shows a k-gram generator 304, located in spam detector 120. The k-gram generator 304 generates k-grams from the spam corpus 302. For each spam e-mail in the spam corpus 302, the k-gram generator 304 generates at least one k-gram from the e-mail, as shown in FIG. 2. The process of generating k-grams from a spam e-mail is described in greater detail above with reference to FIG. 2. Once k-grams are generated for all e-mail in the spam corpus 302, an exhaustive k-gram list or database 306 is created. This k-gram list 306 includes all k-grams generated from the entire spam corpus 302. The k-gram list 306 acts like a dictionary for looking up or k-grams from an incoming e-mail and determining whether it is a spam e-mail.

Additionally, for each k-gram in the k-gram list 306, the k-gram generator 304 can generate a k-gram weight value corresponding to a k-gram. The process of generating k-gram weight values for k-grams is described in greater detail above with reference to FIG. 2. Once k-gram weight values are generated for all k-grams in the k-gram list 306, an exhaustive list or database 308 of k-gram weight values is created. This k-gram weight value list 308 includes a k-gram weight corresponding to each k-gram in the k-gram list 306.

In one embodiment of the present invention, the undesirability of an e-mail, i.e., identifying an e-mail as spam, can be scored based on the weights of the e-mail tokens that match the tokens from a honey pot. In another alternative, the undesirability of an e-mail can be scored based on the number of the e-mail tokens that match the tokens from a honey pot.

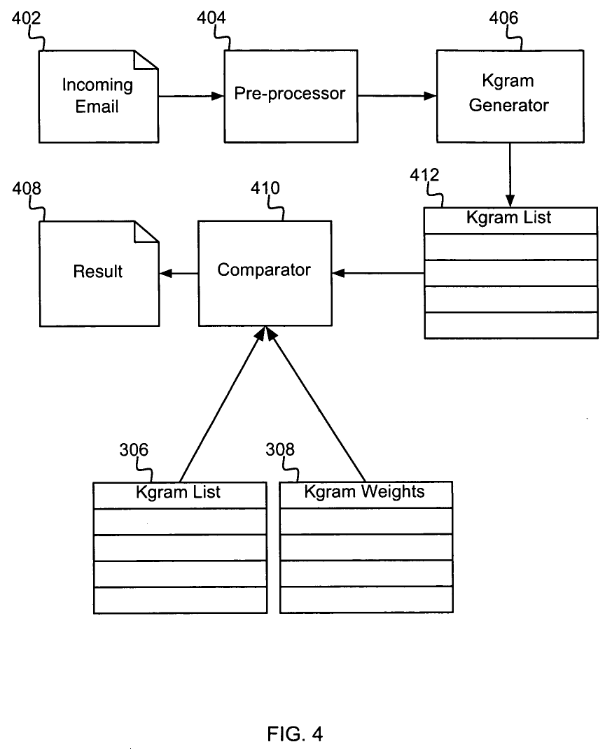

FIG. 4 is block diagram showing the process of detecting undesirable e-mails using similarity calculations, according to one embodiment of the present invention. FIG. 4 shows the process by which an incoming e-mail 402 is processed to determine whether it is a spam e-mail. FIG. 4 shows an optional pre-processor 404. Pre-processor 404 performs the tasks of pre-processing incoming e-mail 402 so as to eliminate spam-filtering countermeasures in the e-mail. Senders of spam e-mail often research spam-filtering techniques that are currently used and devise ways to counter them. For example, senders of spam may counter k-gram spam-filtering techniques by inserting various random characters in an e-mail so as to produce a variety of k-grams. The pre-processor 402 detects these spam-filtering countermeasures in the incoming e-mail 402 and eliminates them.

Below is a summary of techniques used to eliminate the spam-filtering countermeasures used by spammers. The e-mail message is rendered into the text the receiver views, decoding any MIME or HTML it contains as necessary. Text that is not visible or is not likely to be seen by the mail receiver is removed. Thus, if the spammer inserts text countermeasures in a very small or invisible font, those elements are ignored. Common transformations introduced by spammers are rendered ineffective by mapping k-gram variations to a common token. Thus, “Viagra,” and “vlagra” are mapped to the same token. Spaces and punctuation are removed. For example, “v.i.a.g.r.a” and “v i a g r a” are both mapped to “viagra”. The e-mail is also analyzed in its original format to ensure that similarly encoded messages that are encoded similarly.

After pre-processing by pre-processor 404, the e-mail 402 is read by a k-gram generator 406. The k-gram generator 406 generates a set of k-grams for the incoming e-mail, as described in greater detail above with reference to FIG. 2. This results in the creation of a k-gram list 412. This list is then read by the comparator 410, which compares the k-grams in k-gram list 412 with the k-grams in k-gram list 306. That is, for each k-gram in k-gram list 412, comparator 410 does a byte-by-byte (or character-by-character) comparison with each k-gram in the k-gram list 306. For example, the comparator 410 chooses a k-gram pair—one k-gram from the k-gram list 412 and one from the k-gram list 306—and does a byte-by-byte comparison. The comparator 410 performs this action for every possible k-gram pair of k-grams from the lists 412 and 306.

In one embodiment of the present invention, the result 408 of the comparison process of the comparator 410 is a match if a specified matching condition is met. Some examples of such a matching condition include:
1) at least one k-gram pair is found to be identical,
2) a predefined number of k-gram pairs are found to be identical,
3) at least one k-gram pair is found to be substantially similar, and
4) a predefined number of k-gram pairs are found to be substantially similar.

In yet another embodiment of the present invention, the comparison process of the comparator 410 involves the use of the k-gram weights from the k-gram weight value list 308. For each k-gram pair, a byte-by-byte comparison is performed, as described above. Then, it is determined which k-gram pairs are identical or substantially similar. For those k-gram pairs that are determined to be identical or substantially similar, the k-gram weight value (from the k-gram weight value list 308) that corresponds to the k-gram from list 306 is stored into a data structure. All such k-gram weight values that are stored into the data structure are then considered as a whole in determining whether the incoming e-mail 402 is spam e-mail. For example, all k-gram weight values that are stored into the data structure are added. If the resulting summation is greater than a threshold value, then the incoming e-mail 402 is deemed to be spam e-mail. If the resulting summation is not greater than a threshold value, then the incoming e-mail 402 is deemed not to be spam e-mail.

In another embodiment of the present invention, the comparison process using the comparator 410 involves the comparing of k-grams in the incoming e-mails to the k-grams for each group in the spam corpus. The result 408 of the comparison is a match if a specified matching condition is met. Some examples of such a matching condition include:
1) at least one k-gram pair is found to be identical,
2) a predefined number of k-gram pairs are found to be identical,
3) at least one k-gram pair is found to be substantially similar,
4) a predefined number of k-gram pairs are found to be substantially similar, or
5) the result of summing the weights of the matching k-grams is above a specified threshold.

In yet another embodiment of the present invention, the comparison process using the comparator 410 involves the comparing of k-grams in the incoming e-mails to the k-grams for each group in the spam corpus and each group in the good corpus. The result 408 of the comparison is a match if a specified similarity condition is met. Some examples of such a similarity condition include:
1) the group that matches the greatest number of k-gram pairs is from the spam corpus,
2) the group that has the greatest number of substantially similar k-gram pairs is from the spam corpus, or
3) the group that has the greatest sum of the weights of its matching k-grams is from the spam corpus.

The similarity condition can be any metric which measures the similarity of a document to a document group based on the tokens that are present in the document and the document group. In one embodiment of a similarity condition, the similarity of the document to the document group is computed as a function of the similarity of the document to each of the documents in the document group. Suitable functions for combining the similarity of the document to each document in a document group into a single metric include maximum, minimum, and median similarity among the members of the group. In yet another embodiment the similarity of a document to a group is computed using a single document that is representative of the group. The document used to represent the group can either be a single example within the group that is chosen to represent the group or a new document constructed from the most common elements within the documents of the group. For instance, the group could be represented by a document containing all the text that is common among the documents in the group. Similarly, the document containing all the text that appears in any document in the group could be used to represent a group.

The similarity between two documents can be computed as any metric which is a function of the tokens they contain and their weights; such that two identical documents will yield a similarity measure of 1.0 and two completely dissimilar documents will yield a similarity measure of 0.0 and in all other cases the similarity measure should lie between these two limits. There can be many embodiments of such a similarity metric. One embodiment would count the number of identical tokens, which are present in both the documents and divide by the square-root of the product of the number of tokens present in each of the two documents. A more preferred embodiment would be one that uses the weights of the tokens, and adds up the weight of the tokens that are present in both the documents, and then divides by an appropriate normalization factor, such as the square-root of the product of sum of weights of each of the comparing documents. Another embodiment of a similarity metric would be the sum of weights of the tokens present in both the documents divided by the larger of the total weight of tokens in each of the two documents. An even more sophisticated metric would give partial weight, when a token, such as k-gram is partially matched, that is, if not all k bytes are present in the incoming mail, but part of a k-gram is present then part of the weight for the token is added in the similarity metric. This would make the embodiment less sensitive to the counter-measures taken by spammers to hide similarity between their e-mailings.

The computational cost of comparing two documents is dominated by the number of tokens generated for each message. The computational cost of this comparison can be reduced by limiting the number of the tokens generated for each message. For example, token generation could be limited to only those tokens for which the value of a hash function h(x) when divided by a constant N equals zero. This reduces the number of generated tokens by a factor of N, at the cost of making the similarity measure less precise. In one embodiment of the present invention, a multi-stage approach is used to achieve a balance between the computational cost of the similarity function and it's precision. The first stage uses a limited number of tokens to identify the closest M document groups that are most similar to the given e-mail. Then, the following stages use progressively more effective similarity measures to compare the current document to the M groups identified in the previous stage. The similarity functions used in later stages may use more tokens or may use more sophisticated document similarity algorithms such as computing the longest common substring between two documents and comparing it to a threshold.

FIG. 5 is a flowchart showing the control flow of the process of detecting undesirable e-mails using similarity calculations, according to one embodiment of the present invention. FIG. 5 summarizes the process of detecting spam, as described above in greater detail. The control flow of FIG. 5 begins with step 502 and flows directly to step 504.

In step 504, a spam corpus 302 comprising a plurality of spam e-mails is generated by creating a bogus e-mail account where no e-mails are expected or solicited. Thus, any e-mails that are received by this e-mail account are deemed automatically to be, by definition, unsolicited e-mails, or spam. In step 505, the spam corpus is grouped by message similarity. In step 506, the k-gram generator 304 generates k-grams from the spam corpus 302, taking the grouping produced in step 505 into account. For each group of spam e-mails in the spam corpus 302, the k-gram generator 304 generates at least one k-gram from the group. Once k-grams are generated for all e-mail groups in the spam corpus 302, an exhaustive k-gram list or database 306 is created. This k-gram list 306 includes all k-grams generated from the entire spam corpus 302. In step 508, for each k-gram in the k-gram list 306, the k-gram generator 304 can generate a k-gram weight value corresponding to a k-gram. Once k-gram weight values are generated for all k-grams in the k-gram list 306, an exhaustive list or database 308 of k-gram weight values is created. This k-gram weight value list 308 includes a k-gram weight corresponding to each k-gram in the k-gram list 306.

In step 510, incoming e-mail 402 is received and in step 512, it is processed to determine whether it is a spam e-mail. Pre-processor 404 performs the tasks of pre-processing incoming e-mail 402 so as to eliminate spam-filtering countermeasures in the e-mail. After pre-processing by pre-processor 404, in step 514, the e-mail 402 is read by a k-gram generator 406. The k-gram generator 406 generates a set of k-grams for the incoming e-mail 402. This results in the creation of a k-gram list 412.

In step 516, this list is then read by the comparator 410, which compares the k-grams in k-gram list 412 with the k-grams in k-gram list 306. For each k-gram in k-gram list 412, comparator 410 does a byte-by-byte (or character-by-character) comparison with each k-gram in the k-gram list 306. I.e., the comparator 410 chooses a k-gram pair—one k-gram from the k-gram list 412 and one from the k-gram list 306—and does a byte-by-byte comparison. The comparator 410 performs this action for every possible k-gram pair of k-grams from the lists 412 and 306. The result 408 of the comparison process of the comparator 410 is a match if any of a variety of statements are found to be true (see above), such as an identical match between at least one k-gram pair. In step 518, based on whether there is a match in step 516, the incoming e-mail 402 is deemed to be either spam or non-spam e-mail. The incoming e-mail 402 can then be filed, viewed by the user, deleted, processed or included in the spam corpus 302, depending on whether or not it is determined to be spam. In step 520, the control flow of FIG. 5 stops.

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer system to read such computer readable information.

FIG. 6 is a high level block diagram showing an information processing system useful for implementing one embodiment of the present invention. The computer system includes one or more processors, such as processor 604. The processor 604 is connected to a communication infrastructure 602 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 608 that forwards graphics, text, and other data from the communication infrastructure 602 (or from a frame buffer not shown) for display on the display unit 610. The computer system also includes a main memory 606, preferably random access memory (RAM), and may also include a secondary memory 612. The secondary memory 612 may include, for example, a hard disk drive 614 and/or a removable storage drive 616, representing a floppy disk drive, a magnetic tape drive, an optical disk drive, etc. The removable storage drive 616 reads from and/or writes to a removable storage unit 618 in a manner well known to those having ordinary skill in the art. Removable storage unit 618, represents a floppy disk, a compact disc, magnetic tape, optical disk, etc. which is read by and written to by removable storage drive 616. As will be appreciated, the removable storage unit 618 includes a computer readable medium having stored therein computer software and/or data.

In alternative embodiments, the secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computer system.

The computer system may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (i.e., channel) 626. This channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 606 and/or secondary memory 612. Computer programs may also be received via communications interface 624. Such computer programs, when executed, enable the computer system to perform the features of the present invention as discussed herein. In particular, the computer programs, when executed, enable the processor 604 to perform the features of the computer system. Accordingly, such computer programs represent controllers of the computer system.

The described embodiments of the present invention are advantageous as they allow for the quick and easy identification of undesirable e-mails. This results in a more pleasurable and less time-consuming experience for consumers using e-mail programs to manage their e-mails.

Another advantage of the present invention is the ability to circumvent spam-filtering countermeasures employed by senders of unsolicited e-mails. By using k-grams, weighted k-grams and preprocessing steps to delete spam-filtering countermeasures, the present invention increases the probabilities of detecting undesirable e-mails and decreases the probabilities of a false positive. This results in increased usability and user-friendliness of the e-mail program being used by the consumer.

Another advantage of the present invention is the development of a spam-detecting system that is largely immune to the addition, deletion or modification of content in an incoming e-mail. Through the use of k-grams, or signatures, the present invention is able to detect a spam e-mail even if it has been altered in a variety of ways. This is beneficial as it results in the increased detection of spam e-mail.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for detecting undesirable e-mail, the method comprising:
collecting a plurality of undesirable e-mails;
arranging the plurality of undesirable e-mails into a plurality of groups;
generating, for each group, at least one token, thereby producing a plurality of tokens for the plurality of undesirable e-mails;
receiving a first e-mail;
generating at least one token for the first e-mail;
causing a comparison of the at least one token for the first e-mail with at least one of the plurality of tokens for the plurality of undesirable e-mails; and
identifying the first e-mail as an undesirable e-mail if the at least one token for the first e-mail matches any of the plurality of tokens for the plurality of undesirable e-mails.

2. The method of claim 1, further comprising:
deleting a first token of the plurality of tokens for the plurality of undesirable e-mails if the first token matches a token for a desirable e-mail.

3. The method of claim 1, further comprising:
deleting a first token of the plurality of tokens for the plurality of undesirable e-mails if the first token matches another token of the plurality of tokens for the plurality of undesirable e-mails.

4. The method of claim 1, wherein a token comprises a string of contiguous characters from an e-mail.

5. The method of claim 1, wherein a token comprises a string of contiguous characters of fixed length from an e-mail.

6. The method of claim 1, wherein a token comprises a string of characters from an e-mail, wherein a hash of the characters meet a criteria.

7. The method of claim 1, wherein a token comprises a k-gram including a string of 20 to 30 consecutive bytes from an e-mail.

8. The method of claim 1, wherein the first step of generating comprises:
generating, for each group, at least one token, thereby producing a plurality of tokens for the plurality of undesirable e-mails, wherein a weight based on token length is associated with each token.

9. The method of claim 1, wherein the first step of generating comprises:
generating, for each group, at least one token, thereby producing a plurality of tokens for the plurality of undesirable e-mails, wherein a weight based on token frequency is associated with each token.

10. The method of claim 1, wherein the first step of generating comprises:
generating, for each group, at least one token, thereby producing a plurality of tokens for the plurality of undesirable e-mails, wherein a weight based the relative frequency of a token within groups as compared with its frequency between groups.

11. The method of claim 1, wherein the step of causing to compare comprises:
performing a byte-by-byte comparison of the at least one token for the first e-mail with the plurality of tokens for the plurality of undesirable e-mails, wherein a match is found if the at least one token for the first e-mail is identical to at least one of the plurality of tokens for the plurality of undesirable e-mails.

12. The method of claim 1, wherein the step of identifying comprises:
identifying the first e-mail as an undesirable e-mail if the at least one token for the first e-mail matches more than one of the plurality of tokens for the plurality of undesirable e-mails.

13. The method of claim 1, further comprising:
scoring the first e-mail for undesirability based on the number of tokens for the first e-mail that match the plurality of tokens for the plurality of undesirable e-mails.

14. The method of claim 1, further comprising:
scoring the first e-mail for undesirability based on weights of the tokens for the first e-mail that match the plurality of tokens for the plurality of undesirable e-mails.

15. The method of claim 1, wherein an e-mail is deemed undesirable if the e-mail is sent to a first e-mail account.

16. The method of claim 1, wherein an e-mail is deemed undesirable if the e-mail is identified as undesirable by the user.

17. The method of claim 1, with the additional step of deleting spam-filtering countermeasures in at least one e-mail.

18. An information processing system for detecting undesirable e-mail, comprising:
a memory for collecting a plurality of undesirable e-mails;
a receiver for receiving a first e-mail; and
a processor configured for:
arranging the plurality of undesirable e-mails into a plurality of groups;
generating, for each group, at least one token, thereby producing a plurality of tokens for the plurality of undesirable e-mails;
generating at least one token for the first e-mail;
causing a comparison of the at least one token for the first e-mail with at least one of the plurality of tokens for the plurality of undesirable e-mails; and
identifying the first e-mail as an undesirable e-mail if the at least one token for the first e-mail matches any of the plurality of tokens for the plurality of undesirable e-mails.

19. The information processing system of claim 18, the processor further configured for:
deleting a first token of the plurality of tokens for the plurality of undesirable e-mails if the first token matches a token for a desirable e-mail.

20. The information processing system of claim 18, the processor further configured for:
deleting a first token of the plurality of tokens for the plurality of undesirable e-mails if the first token matches another token of the plurality of tokens for the plurality of undesirable e-mails.

21. The information processing system of claim 18, wherein a token comprises a string of contiguous characters from an e-mail.

22. The information processing system of claim 18, wherein a token comprises a string of contiguous characters of fixed length from an e-mail.

23. The information processing system of claim 18, wherein a token comprises a string of characters from an e-mail, wherein a hash of the characters meet a criteria.

24. The information processing system of claim 18, wherein a token comprises a k-gram including a string of 20 to 30 consecutive bytes from an e-mail.

25. The information processing system of claim 18, wherein an e-mail is deemed undesirable if the e-mail is sent to a first e-mail account.

26. A computer readable medium including computer instructions for detecting undesirable e-mail, the computer instructions including instructions for:
collecting a plurality of undesirable e-mails;
arranging the plurality of undesirable e-mails into a plurality of groups;
generating, for each group, at least one token, thereby producing a plurality of tokens for the plurality of undesirable e-mails;
receiving a first e-mail;
generating at least one token for the first e-mail;
causing a comparison of the at least one token for the first e-mail with at least one of the plurality of tokens for the plurality of undesirable e-mails; and
identifying the first e-mail as an undesirable e-mail if the at least one token for the first e-mail matches any of the plurality of tokens for the plurality of undesirable e-mails.

27. A method for detecting undesirable e-mail, the method comprising:
collecting a plurality of desirable and undesirable e-mails;
generating at least one token for the plurality of desirable and undesirable e-mails,
receiving a first e-mail;
generating at least one token for the first e-mail;
causing a comparison of the at least one token for the first e-mail with at least one of the plurality of tokens for the plurality of desirable or undesirable e-mails; and
identifying the first e-mail as an desirable or undesirable e-mail based on the result of the comparison between at least one token for the first e-mail with at least one of the plurality of tokens for the plurality of desirable or undesirable e-mails.

28. The method of claim 27, wherein the first generating step comprises creating at least one token for the plurality of undesirable e-mails, wherein the token does not occur more than a specified number of times in the plurality of desirable e-mails, thereby producing a plurality of tokens for the plurality of undesirable e-mails;

29. The method of claim 27, wherein the second generating step comprises creating at least two tokens for the first e-mail and the comparison step comprises comparing the at least two tokens for the first e-mail with at least two of the plurality of tokens for the plurality of desirable or undesirable e-mail.

30. The method of claim 27, wherein the first step of generating comprises:
generating, for each e-mail, at least one token, thereby producing a plurality of tokens for the plurality of undesirable e-mails, wherein a weight based on token length is associated with each token.

31. The method of claim 27, wherein the first step of generating comprises:
generating, for each group, at least one token, thereby producing a plurality of tokens for the plurality of undesirable e-mails, wherein a weight based on token frequency in desirable and undesirable e-mail is associated with each token.

32. The method of claim 27, wherein the step of causing to compare comprises:
performing a byte-by-byte comparison of the at least one token for the first e-mail with the plurality of tokens for the plurality of undesirable e-mails, wherein a match is found if the at least one token for the first e-mail is identical to at least one of the plurality of tokens for the plurality of undesirable e-mails.

33. The method of claim 27, wherein the step of causing to compare comprises:
performing a byte-by-byte comparison of the at least one token for the first e-mail with the plurality of tokens for the plurality of undesirable e-mails, wherein a match is found if the at least one token for the first e-mail is similar to at least one of the plurality of tokens for the plurality of undesirable e-mails.

34. The method of claim 27, wherein the step of identifying comprises:
identifying the first e-mail as an undesirable e-mail if the at least one token for the first e-mail matches more than one of the plurality of tokens for the plurality of undesirable e-mails.

35. The method of claim 27, further comprising:
scoring the first e-mail for undesirability based on the number of tokens for the first e-mail that match the plurality of tokens for the plurality of undesirable e-mails.

36. The method of claim 27, further comprising:
scoring the first e-mail for undesirability based on weights of the tokens for the first e-mail that match the plurality of tokens for the plurality of undesirable e-mails.

37. The method of claim 27, wherein an e-mail is deemed undesirable if the e-mail is sent to a first e-mail account.

38. The method of claim 27, wherein an e-mail is deemed undesirable if the e-mail is identified as undesirable by the user.

39. The method of claim 27, with the additional step of deleting spam-filtering countermeasures in at least one e-mail.

40. A method for detecting undesirable e-mail, the method comprising:
collecting a plurality of undesirable e-mails;
generating at least one token for the plurality of undesirable e-mails, thereby producing a plurality of tokens for the plurality of undesirable e-mails;
generating a weight associated with each of the plurality of tokens, wherein a weight is based on token length;
receiving a first e-mail;
generating at least one token for the first e-mail;
causing a comparison of the at least one token for the first e-mail with at least one of the plurality of tokens for the plurality of undesirable e-mails; and
identifying the first e-mail as an undesirable e-mail if the at least one token for the first e-mail matches any of the plurality of tokens for the plurality of undesirable e-mails.
